(19) United States
(12) Patent Application Publication
(10) Pub. No.: US 2013/0218747 A1
(43) Pub. Date: Aug. 22, 2013

(54) Implied Volatility Based Pricing and Risk Tool and Conditional Sub-Order Books

(71) Applicant: Lawrence J. Abrams, Buffalo Grove, IL (US)

(72) Inventor: Lawrence J. Abrams, Buffalo Grove, IL (US)

(21) Appl. No.: 13/850,462

(22) Filed: Mar. 26, 2013

Related U.S. Application Data
(63) Continuation of application No. 12/949,163, filed on Nov. 18, 2010, now abandoned.
(60) Provisional application No. 61/262,822, filed on Nov. 19, 2009.

(51) Int. Cl. G06Q 40/04

(52) U.S. Cl. CPC G06Q 40/04
USPC 705/37

(57) ABSTRACT

The Book Order Management (BOM) system provides a fully automated and efficient electronic trading environment for derivatives trading. The BOM system allows traders to electronically, in real time, both make two sided markets in any option or combination of options, and issue quotations for immediate use, so that the trader providing the quotation has the opportunity to re-evaluate and change markets if conditions change. The BOM system provides a way to efficiently determine whether the conditions placed on a contingent order are met and guaranteed, using a lock (freeze) and reserve procedure.

### RELATED APPLICATIONS

The present application is a continuation of U.S. patent application Ser. No. 12/949,163, filed Nov. 18, 2010, which application claims the benefit of the filing date under 35 U.S.C. §119(e) of Provisional U.S. Patent Application Ser. No. 61/262,822, filed Nov. 19, 2009, both of which applications are hereby incorporated in their entirety by reference.

### BACKGROUND OF THE INVENTION

1. Technical Field

This disclosure concerns a system and method for electronically trading in derivative markets. In particular, this disclosure relates to an effective way to provide a fully automated and efficient electronic trading environment for derivatives trading.

2. Background Information

Similar to options, stocks and futures historically traded in an open outcry environment on the floor of exchanges worldwide. Unlike options, stocks and futures trading has converted to a fully automated computer based trading system. Stocks and futures trading using a fully automated computer based system has allowed the entire world to participate in stocks and futures markets real-time so that when orders are placed, canceled, or executed, customers get immediate feedback. As a result, the liquidity of stocks and futures has improved and trading volumes have increased exponentially for exchanges worldwide. Despite the fact that exchanges have listed options products on computer based systems, options continue to trade primarily in the open outcry environment. Some exchanges may maintain and display a single electronic order book with bids and offers and the size of each bid and offer for specific options markets. Such electronic order books are limited and do not accommodate all types of orders, which will be explained in detail below. Most of the options trading that occurs electronically can be accounted for by large dealers who make a few trades with one another. Electronically traded options involve very little public participation and do not provide the liquidity that exists in the open outcry environment. Neither the current computer based system for trading options nor the open outcry environment provide features necessary for customers to participate in the market, realize the efficiencies, liquidity and market transparency provided by a fully automated computer based trading systems similar to those used for stocks and futures.

Options are traded in an open outcry environment on the floor (also know as the “pit”) of exchanges worldwide. Options trade on underlying products. In other words, an option is a contract giving the owner the right to buy or sell an underlying product based on the terms of the contract. Options that trade on an exchange generally are derivatives of stocks, commodities, bonds or other interest rate products, foreign currencies, equity indexes, or futures contracts. There are also options that are less standardized that trade in the over the counter market (OTC). An entire class of options (e.g., multiple strikes and expirations) trade for any given underlying product. For example, at the Chicago Mercantile Exchange, Futures contracts trade on the S&P 500 stock index on a quarterly cycle (e.g., futures contract for March, June, September, and December). For each futures contract (e.g., March S&P 500), there can be literally hundreds of options listed. In addition, a substantial amount of trading in options involves spread trading. In spread trading, combinations of options and/or combinations of options and the underlying contract trade as an individual entity.

Currently, few outside the members of the exchange have full access to the options market at any given time and customers participate in option markets through the use of floor brokers. Floor brokers receive orders and try to execute the orders in the pit at the best possible price. In the best of circumstances the broker fills the order at the best price and then reports the fill to the customer. In active markets, the broker is not always able to get the best price, and communication between the broker and customer is inefficient. In an active market, minutes or even hours might pass before the customer is given the status of an order. Also, where a customer changes an order, the customer often waits for long periods of time before being able to confirm whether the change is successful.

In the open outcry environment, buyers and sellers (option market traders) meet and physically hold a continuous two sided auction. Options traders (hereinafter “traders”) each keep an order book (also known as a deck). Orders get matched with bids and offers in the pit. Traders generally include hedgers, speculators, and professional options market makers. Hedgers include commercial interests and producers and commercial users of products. Speculators include hedge funds, as well as large and small traders. Professional options market makers provide liquidity to the market. The different types of traders have different approaches to trading. Hedgers generally trade based on the price of the underlying (e.g., the price of item that is the basis for an option) and the business needs of the hedger. Hedgers focus on accomplishing specific tasks with the use of options. Speculators may use predictive models based on the price of an underlying and use options strategies to trade according to the speculator's opinions and predictions. Professional market makers (PMMs) approach the market in a much different manner. PMMs participate in a market by providing a market for hedgers and speculators to use. Through the use of options pricing models, a PMM can calculate what the PMM considers the fair value (also known as theoretical value (TV)) of an option to be at any given time. PMMs provide constant bids and offers that the PMMs believes have edge (e.g., a buy price below what the PMM believes to be the fair value and a sell price above what the PMM believes to be the fair value). A PMM changes position in a market based on the collective trades occurring in the market, in an attempt to make trades with significant edge that satisfy risk parameters related to the options portfolio of the PMM. In order to make options markets more accessible to the public, efficient and liquid, a tool is needed that implements the professional market maker electronically and allows each type of trader to price, trade and manage options and combinations of options compatible of accommodating the approach of each type of trader.

PMMs have the challenge of making a two sided market (bid and offer) simultaneously in hundreds of different potential markets (e.g., different potential markets including different strikes, calls, puts, different months, spreads) while managing the risk that a specific trade or series of trades may create, as well as managing an existing portfolio. In the pit, a PMM prices an option by using mathematical valuation model (e.g., Black-Scholes model). A mathematical valuation model (model) contains several variables including the price of the underlying, the strike price, time to expiration, the interest rate, and the future volatility of the underlying product. A trader generally knows the variables for a model, at any given time, with the exception of future volatility. A model can calculate future volatility as implied volatility (IV), using reverse formulation based on the price of the option, which allows the trader to compare the price of options at any given time based on IV. Therefore, the trader can make a decision regarding whether to buy or sell an option based on IV. The trader can specify the level of IV at which the trader is willing to bid (IVB) and the level of IV at which the trader is willing to sell (IVA) to establish the trader's market. Based on the trader's variables, upon changes in the price of the underlying, the option prices for the trader can be recalculated to reflect the level of IVB and IVA. In addition, each option has quantifiable levels of risk. A model may use the risk parameters (e.g., risk sensitivity parameters) to measure the sensitivity of a specific option, including: price move of the underlying—delta; IV sensitivity of the options—vega; curvature of the vega—gamma; and time decay of a specific option—theta.

The price and size of the markets for a PMM may be determined based on IVB and IVA, and risk sensitivity parameters. The PMM may manage risk and compare options to each other in terms of relative price and risk, using IVB, IVA and risk sensitivity parameters. In the options pit, the PMM face the daunting task of immediately responding to a request from brokers and other traders to make two sided markets in any of the options or combinations of options that are tradable. The PMM responds to requests based on many factors including: the opinion of the PMM regarding IV; the price of the underlying; other orders in the pit; the current position of the PMM; and the assessment of the underlying regarding the direction of the price and liquidity. The PMM has the opportunity to make split second decisions as to what to trade and what not to trade. The PMM must also manage their risk on a continual basis, because risk has a direct effect on the ongoing activity in the market. For example, as a result of selling call options at a certain IV level, the PMM may need to adjust their market exposure in the underlying. The PMM may also decide to change their level of IV at that strike or at other strikes before making additional trades. At the same time that the PMM is trading based on IV and risk management, the customer (hedger and speculator) generally is interested in making particular trades or combinations of trades at specific prices in specific quantities. The customer requires a transparent and liquid market where the orders of the customer can be traded, regardless of the simplicity or complexity of an order.

Currently, the exchange only provides a regular order book (ROB) that ranks all bids and offers by price for one underlying product. The ROB works well in the underlying markets because only one underlying product is traded at any given time. The ROB does not work efficiently in the options market, because multiple options may exist to trade for one underlying. Several problems are associated with using only a ROB in the options market. The ROB does not provide a PMM the ability to efficiently change quotes for each option at a speed comparable to the rate of change that occurs to the underlying. For most products, there are hundreds of options for each underlying. Although systems exist that can calculate the theoretical price of an option based on IV, also referred to as IV pricing, an automated quote system that generates bids and offers based on IV does not exist that can adequately perform the number of concurrent computations needed relative to the frequency of change in the price of the underlying. Many of the current systems used to calculate IV pricing perform the calculation at the service provider level. In order for the IV pricing calculation to perform satisfactorily, the calculation may need to be calculated at the exchange level.

A PMM monitors and adheres to particular risk parameters. The PMM may have a certain tolerance of delta, vega, and gamma as well as skew risk (e.g., the difference in IV at different strikes, on several different levels (e.g., per trade, per month, per portfolio). The risk parameters change based on many factors including liquidity in the underlying, capital in the account and event driven conditions (e.g., an anticipated report that is about to be released). In addition, the PMM has other imposed restrictions, for example restrictions imposed by the clearing firm used by the PMM or the Exchange.

An automated quote system does not exist that generates bids and offers based on IV in every available option while providing the PMM with guaranteed safe guards necessary for the PMM to control risk. Although systems exist, at the service provider and exchange level, that reduce exposure to risk, there are no systems that guarantee risk control. An automated quote system does not exist that ensures that at any given time multiple trades will not take place simultaneously that cause the risk tolerances of the PMM to be exceeded. For example, the PMM, in the Soybean options pit, may be willing to buy or sell 100 contracts at any given strike at any given time. In the Soybean options pit, over 300 different options classes may exist. Although such a scenario would not occur in the open outcry environment, under an automated quote system that generates bids and offers based on IV, the potential exists for a bid or offer of a PMM to be hit or taken, respectively, simultaneously in 200 different options. As a result, instead of having a position of 100 contracts, the PMM would have a position of 20,000 contracts.

In the open outcry environment two very specific protocols exist. Under the first protocol, a PMM is expected to make a two sided market in any option or combination of options that a broker requests at any given time. If the quotation is the best in the pit (highest bid or lowest offer), the broker can immediately execute the trade with the PMM, which address the problem of not being able to calculate all options and combinations with each change in the underlying. Under the first protocol, the PMM only has to perform the calculation for a particular option and particular combinations of options with each change in the underlying. Under the second protocol, the quotation provided is for immediate use only and the trader has the right to re-evaluate and change markets if the trade is not immediately executed. Whether the trade is executed or not, the PMM uses the information to adjust all future quotes, therefore, while the PMM is expected to make a market in response to any request, the quote provided by the PMM is for immediate use and the PMM is not expected to honor more than one quotation at a time.

The extraordinary technical challenges associated with providing a fully automated and efficient electronic trading environment for derivatives trading includes allowing traders to electronically make two sided markets in any option or combination of options that the traders are willing to trade at any given time, and issue quotations in such a manner that the trader providing the quotation has the opportunity to re-evaluate and change markets in the event a trade corresponding to a quotation is executed.

A need has long existed for a system and method that allows traders to electronically, in real time, both make two sided markets in any option or combination of options that the traders are willing to trade at any given time, and issue quotations in such a manner that the trader providing the quotation has the opportunity to re-evaluate and change markets in the event a trade corresponding to a quotation is executed.

### SUMMARY

The Book Order Management (BOM) system and method provide a fully automated electronic environment for traders to trade options and other products. The BOM system allows traders to submit pricing and risk matrix (PRM) parameters and trading criteria used to electronically trade options and other derivative products in real time. In one implementation, traders may submit PRM parameters and trading criteria to an exchange through an interface provided by a service provider. The service provider may transmit the PRM parameters and trading criteria to the BOM system administered by the exchange. The service provider may provide traders with analysis tools that assist traders in determining the PRM parameters and trading criteria to submit to the exchange, in addition to providing other real-time monitoring and trading tools. Traders may submit PRM data directly to the exchange. The BOM system provides a way for traders to participate in the options market in real time, and realize the efficiencies, liquidity and market transparency provided by a fully automated options trading system. The BOM system provides a way to receive and analyze bids and offers from traders for multiple trade classes. The BOM system includes logic to receive PRM parameters from each trader and generate and maintain corresponding order books for each trader for each trade class. The BOM system calculates trading criteria for each trader and transmits the trading criteria to one or more of the order books of the trader, based on the PRM parameters and other criteria.

Customers place market orders, limit orders, spread market orders, or spread limit orders with brokerage firms who submit the orders to the exchange via the BOM system. The BOM system evaluates each order before routing it to the appropriate book and executes each trade based on the PRM parameters, risk sensitivity parameters and trading criteria of the traders involved in the trade. The BOM system allows users to specify risk controls, including PRM parameters, risk sensitivity parameters and trading criteria for groups of accounts. For instance, a trading firm may have several traders trading for whom the firm may want to limit the firm's and individual trader's risk exposure, and/or all or a portion of the traders in the firm. The BOM system may allow users to combine risk controls based on any number of factors, such as whether a trade is for a particular commodity group, and the proprietary trading group. The BOM system matches orders with the best counterparty available. However, unlike the outcry environment, the BOM system searches for the best match among the orders known to the BOM system, in contrast to a trader in the pit who would normally participate in markets in the area of the pit where the trader is located on the floor of the outcry environment. The BOM system has the ability to monitor and execute conditional orders based on changing conditions within the market. In one implementation, the exchange controls the BOM system and order books so that the exchange knows the market position of each trader at any given point in time and can control all contingent orders in the marketplace. Contingencies may include making trades in different markets, optionally at different exchanges and different types of product, as well as events external to the primary market.

The BOM system maintains a regular order book (ROB) and may transmit the trading criteria of a trader to one or more conditional sub-order books (CSBs). The BOM system continuously monitors and updates the ROB and CSBs. The CSBs include different criteria for storing, validating and executing trades for orders received. The CSBs may include a conditional order book (COB), a spread order book (SOB), and a volatility order book (VOB) that are derived from the PRM parameters for each trader. In one implementation, the BOM system includes logic to generate a total order book (TOB) that aggregates the ROB, COB, SOB and VOB for each trader and renders the TOB in a display area for viewing. The TOB is a trusted source of aggregated Bids and Offers located in the ROB, COB, SOB and VOB for display in the TOB. The BOM system maintains in the TOB the highest bid and lowest offer in the ROB, COB, SOB and VOB. Trades may be considered to originate from the TOB and routed to/from the ROB, COB, SOB and VOB by the BOM. The BOM system monitors changes related to the trade classes, PRM parameters, trading criteria, the regular order book (ROB) and the CSBs for each trader. The TOB ranks and stores all bids and offers and matches bids with orders, based on price and the current market is based on the highest bid and the lowest offer. The BOM system includes a top level TOB (TTOB) that aggregates all traders' TOBs. The BOM system may provide the TTOB to the public customer.

The BOM system uses the PRM parameters and trade criteria to analyze orders and determine whether to transmit an order to a particular order book. Based on the PRM parameters, the BOM system may calculate trading criteria for each trader including an implied price bid, the size of a potential trade using the implied price bid, an implied price offer, a size of a potential trade using the implied price offer, and risk sensitivity measurements. The risk sensitivity measurements may include a price move of the underlying (delta measurement), an implied volatility move (vega measurement), a curvature of vega plotted graphically (gamma measurement), and a time decay of an option for the item being traded in the trade class (theta measurement).

The BOM system solves the technical problems associated with providing traders with the ability to electronically make two sided markets in any option or combination of options that another trader requests at any given time and issue quotations for immediate use only so that the trader providing the quotation has the opportunity to re-evaluate and change markets, maintaining guaranteed risk control.

Other systems, methods, and features of the tool will be, or will become, apparent to one with skill in the art upon examination of the following figures and detailed description. It is intended that all such additional systems, methods, features and advantages be included within this description, be within the scope of the tool, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the tool. Moreover, in the figures, like referenced numerals designate corresponding parts or elements throughout the different views.

FIG. 1 illustrates one example implementation of the Book Order Management (BOM) system.

FIG. 2 shows an example of the BOM system configuration.

FIG. 3 illustrates a Price and Risk matrix (PRM) parameters.

FIG. 4 shows the logic flow the BOM system configuration may take to update the ROB, COB, SOB, and VOB.

FIG. 5 shows the logic flow the BOM system configuration may take to perform trade allocation when an order is received.

FIG. 6 illustrates the logic flow the BOM system configuration may take to perform to execute a trade when an order is received.

FIG. 7 illustrates the logic flow the BOM system configuration may take to satisfy a spread order.

FIG. 8 illustrates the logic flow the BOM system configuration may take to perform the order process.

### DETAILED DESCRIPTION

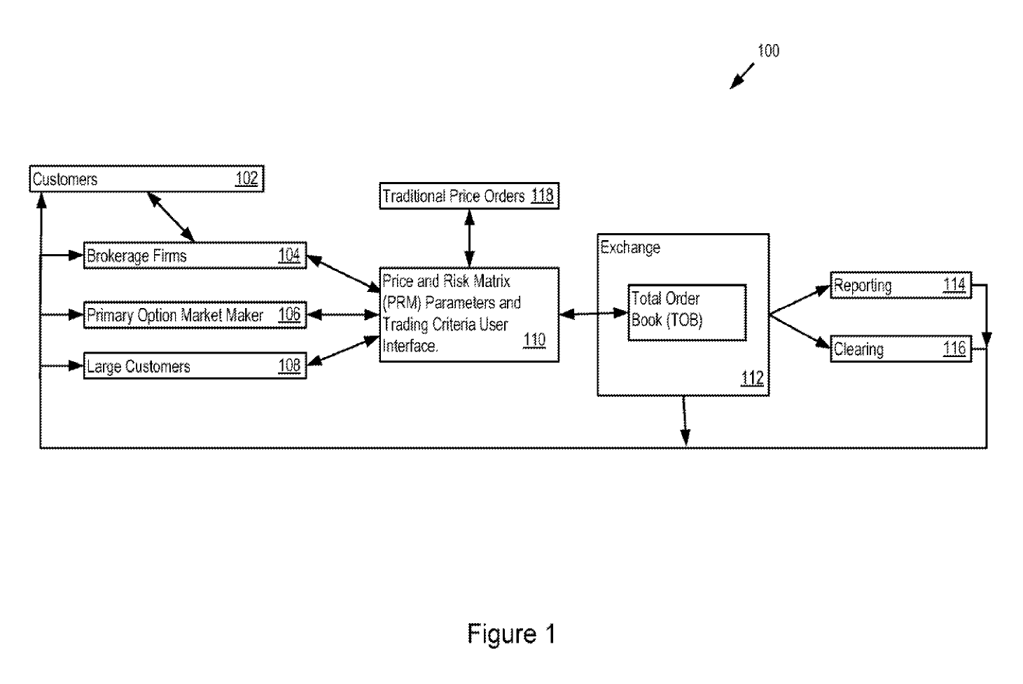

FIG. 1 illustrates one example implementation of the Book Order Management (BOM) system 100. The BOM system 100 may include an interface for customers 102, brokerage firms 104, primary options market makers (PMMs) 106 and large customer 108 to submit trading criteria and PRM parameters to the BOM system 100. In one implementation, brokerage firms 104, primary options market makers (PMMs) 106 and large customer 108 as traders may submit PRM parameters and trading criteria to an exchange 112 through a PRM parameters and trading criteria user interface 110 provided by a service provider. Traditional price orders 118 may also be submit to the exchange 112 through the PRM parameters and trading criteria user interface 110. In one implementation, the BOM system 100 may be controlled and administered by an exchange 112. The BOM system 100 may be configured to interface with reporting systems 114, and clearing systems 116. The exchange, reporting systems 114 and the clearing systems 116 may provide trading information to the customers 102, brokerage firms 104, primary options market makers (PMMs) 106 and large customer 108.

The BOM system may include a user interface for traders to submit PRM parameters. In one implementation, the BOM system computes PRM parameters for traders. In another implementation, the BOM system receives PRM parameters from systems external to the BOM system. For example, the interest rate parameter may be calculated using a sophisticated predictive model specific to forecasting interest rates. In another example, external systems that evaluate and manage risk may provide risk parameters to the BOM system. In one implementation, an external system calculates the implied volatilities based on instructions submitted by a trader and the results of the calculation are submitted to the BOM system, in the form of one or more PRM parameters. Although many of the current systems used to calculate IV pricing perform the calculation at the service provider level, the BOM system may calculate the IV pricing at the exchange level in order to optimize the calculation performance. The BOM system may be implemented in any number of configurations. For example, the PRM and VPR functions may be operated by the exchange, and/or a service provider may deliver the PRM and VPR functions to users of the BOM system.

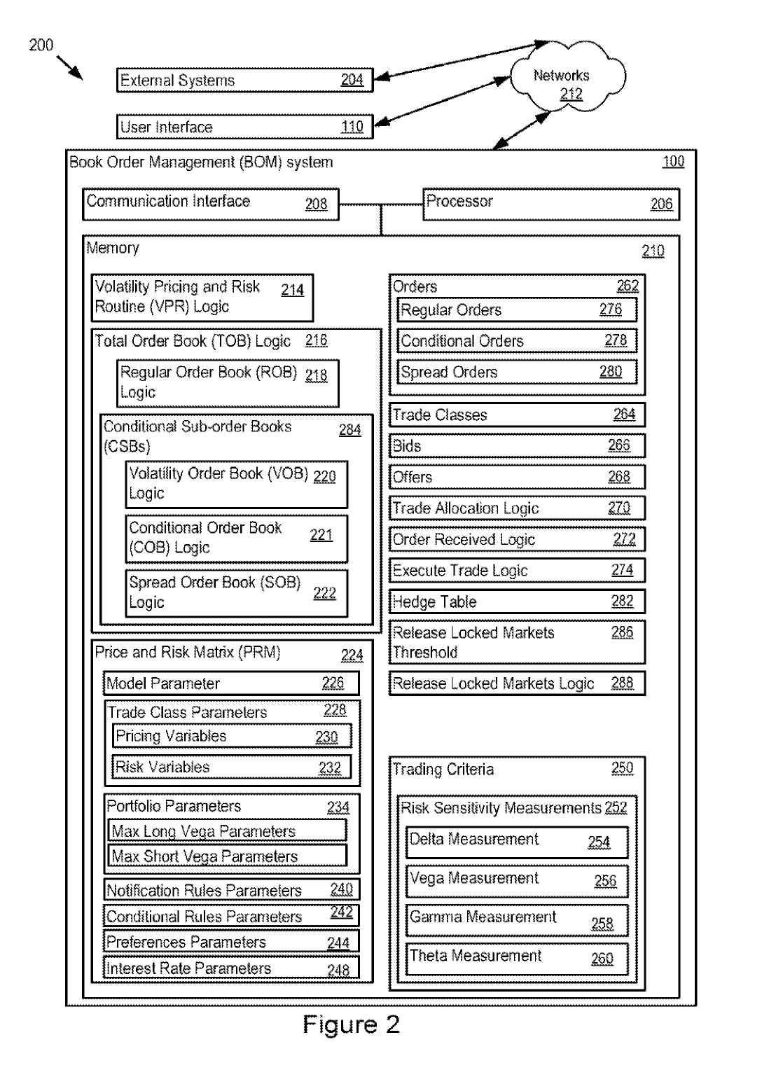

FIG. 2 shows an example BOM system configuration 200. The BOM system configuration includes the BOM system 100, the user interface 110 and external systems 204. The BOM system 100 includes a processor 206, communication interface 208 and memory 210 in communication through a network or networks (e.g., the Internet 212). The BOM system 100 communicates with the various components of the BOM system configuration 200 using the communication interface 208. The processor 206 in communication with the memory 210 invokes the logic stored in the memory 210, including: the volatility pricing and risk routine logic (VPR) logic 214; the total order book (TOB) logic 216; the regular order book logic (ROB) 218; the volatility order book (VOB) logic 220; the conditional order book (COB) logic 221; and spread order book (SOB) logic 222. The BOM system configuration 200 may include any number and combination of order books and corresponding logic to generate and maintain the order books.

The memory 210 may also include a price and risk matrix (PRM) 224 that includes PRM parameters. In one implementation, the PRM 224 may include: a model parameter 226 that indicates a model to use with particular variables and calculation rules to apply to the variables and trade class parameters 228. The trade class parameters 228 may indicate the trade classes in which the trader desires to trade and correspond to trade class pricing variables 230 and trade class risk variables 232. The PRM parameters 224 may further include portfolio parameters 234, notification rules parameters 240, conditional rules parameters 242 that indicate under what conditions a trade may be executed, preferences parameters 244 that indicate specific preferences of the trader, and interest rate parameters 248. The memory 210 may further include other trading criteria 250 including risk sensitivity measurements 252. The portfolio parameters 234 may further include other risk sensitivity measures such as the risk sensitivity measurements 252. The risk sensitivity measures may include delta measurements 254, vega measurements 256, gamma measurements 258 and theta measurements 260. The memory 210 may include various types of orders 262, trading classes information 264, bids 266 and offers 268, as well as trade allocation logic 270, order received logic 272, and execute trade logic 274. The various types of orders may include regular orders 276 (e.g., unconditional and non-contingent orders), conditional orders 278 and spread orders 280.

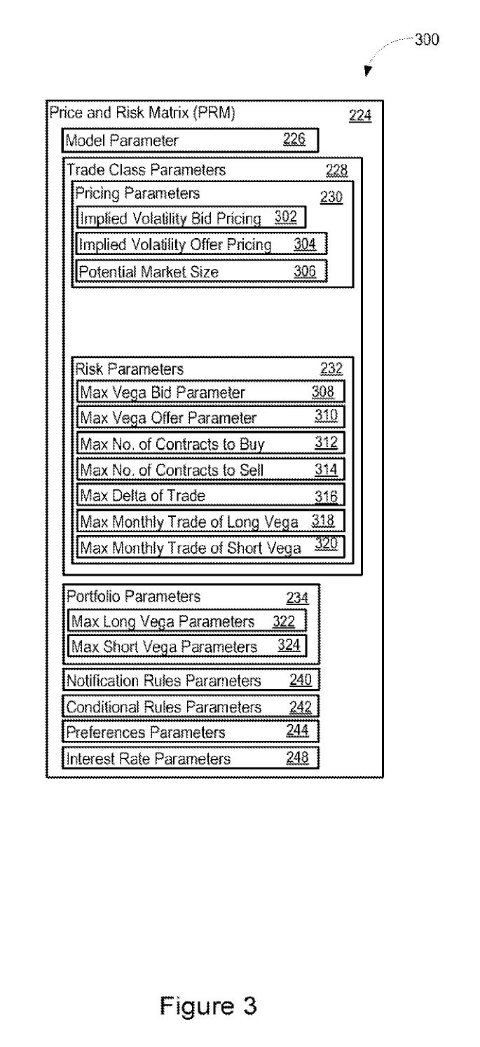

FIG. 3 further illustrates the PRM parameters 300 and indicates that the PRM 224 may include for each trade class an implied volatility bid pricing variable 302, an implied volatility offer pricing variable 304, potential market size 306, a maximum vega bid risk variable 308, a maximum vega offer risk variable 310, a maximum number of contracts to buy risk variable 312, a maximum number of contracts to sell risk variable 314, a maximum delta of trade risk variable, a maximum monthly long vega parameter 318, a maximum monthly short vega parameter 320, a portfolio maximum long vega parameter 322, a portfolio maximum short vega parameter 324, notification rules parameters 240, conditional rules parameters 242, preferences parameters 244, and interest rate parameters 248. Various types of risk variables may be defined for each trade class in the PRM. The notification rules parameters 240 may include a notification rule that directs the VPR logic 214 to update the PRM 224 after each trade or change in an underlying, or any number of events or conditions. The notification rules parameters may include a notification rule that directs the VPR logic 214 to wait for instructions after each trade to determine whether to update the PRM 224. In one implementation, the PRM 224 includes parameters to indicate whether to use relative pricing in which case the trader may submit pivot strike information and skew values (e.g., preferences parameters 242). The VPR logic 214 may send updated calculations to various order books 262. In one implementation, the PRM parameters for a trader are used to create a hedge table 282 that lists all the prices and hedge values (e.g., delta and vega) corresponding to changes in the underlying and implied volatility (IV). The VPR logic 214 may update the hedge table whenever the PRM parameters change. Alternatively, for example, the VPR logic 214 may calculate all the hedge table values for a trade class for all possible values for the underlying before the open of trading.

In one implementation, the BOM system displays, for each trade class 264, the PRM parameters and order books corresponding to a trader. The BOM system may employ logic corresponding to each order book to maintain each order for each trader. The logic for each order book may include different criteria for creating bids and offers, storing, validating and executing trades. The BOM system may include VOB logic 220 that analyzes orders to identify spread orders and transmit the spread orders to the SOB, and identify conditional orders and transmit the conditional orders to the COB of a trader. In one implementation, the BOM system includes COB logic 221 that generates a COB for each trader that receives conditional orders. Conditional orders may be based on one or more contingencies being true. The BOM system analyzes the number of contingencies on which a conditional order is based and determines the number of conditional orders that are concurrently pending for a given trader. Contingencies may include making trades in different markets, optionally at different exchanges and different types of product, as well as events external to the primary market. The COB logic 221 may match the conditional orders to the conditional bids and offers on the COB, and monitor the contingencies to determine whether one of the contingencies evaluates to true. A contingency may be based on any combination of risk sensitivity measurements. In one implementation, the trader specifies the contingencies. In another implementation, the PRM parameters specify the contingencies.

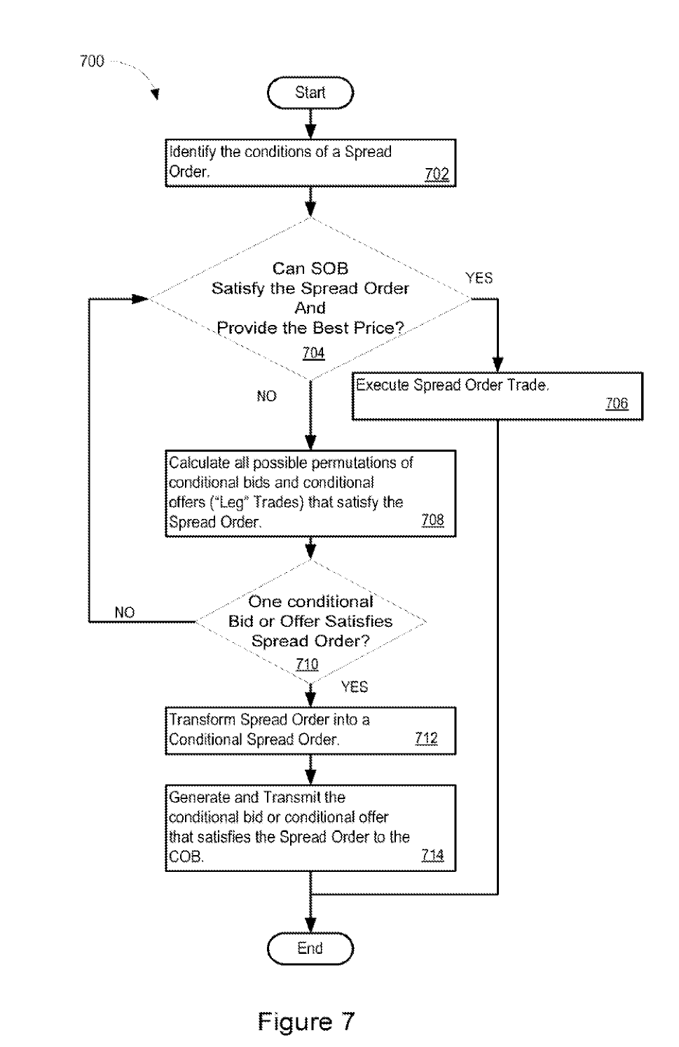

Referring briefly to FIG. 7, the logic flow 700 the BOM system configuration 200 may take to satisfy a spread order 280 is shown. The BOM system may also include SOB logic 222 that receives spread orders. The BOM system may determine whether an order is a spread order based on whether the order includes a combination order (e.g., buy a call and put with the same strike and expiration) that is executed for a single net price (704). When a spread order is received that cannot be filled when received, the spread order is placed on the SOB and identified as a spread order that any trader can trade. In one implementation, the SOB logic analyzes the spread order to determine combinations of bids and offers that may satisfy the spread order (708). The SOB logic 222 may monitor the TOB to identify whether a conditional bid or a conditional offer can be generated to satisfy the spread order. In the event the SOB logic 222 determines that a conditional bid or a conditional offer can be generated to satisfy the spread order (710), the SOB logic 222 transforms the spread order into a conditional spread order and validates that the conditional spread order is valid (712). The SOB logic 222 generates and transmits the respective conditional bid or conditional offer to the COB (714).

Other conditional orders can also be placed directly on the COB. For example, conditional orders placed on the COB can be based on any contingency allowed by the exchange and may include a contingency order to buy an option at a certain price when the bid of a different commodity is above a particular price. The BOM system 100 may limit the number of contingencies on which a conditional trade may be based. Multiple and complex contingencies may add to the number of bids and offers generated by the BOM system 100.

The VOB logic 220 may create spread orders that are transmitted to the SOB. For example, a trader may send information in the PRM 224 that indicates that the trader is willing to buy a certain strike price at a certain IV relative to the IV of another strike price. The VOB logic 220 calculates and transmits spread orders to the SOB. The SOB can transmit orders to the VOB as well. For example, where the BOM system 100 analyzes the VOB of each trader when a spread order is received and transmits the spread order to a VOB of a trader where the spread order meets the trading criteria of the trader.

The BOM system 100 updates the CSBs 284 of each trader. The CSBs 284 hold contingent orders so that when a bid or offer on any one of the CSBs is triggered the BOM system determines whether the conditions placed on the contingent order are met and guaranteed, using a lock (freeze) and reserve procedure. The BOM system 100 and risk controls, such as the lock (freeze) and reserve procedure, and pricing mechanisms may be used for other financial products besides options (e.g., stocks), and used to control the frequency of trades occurring during periods of market volatility as specified by various user selectable parameters. The BOM system guarantees that each level of risk protection is in place. Several volatility levels and risk levels specified by the trader may be submitted concurrently to VPR logic 214. For example, a trader may list IVB/IVA price and risk parameters (e.g., 24% bid with a max of 5000 vega, 23% bid with a max of 10,000 vega, and 22% bid with a max of 10,000 vega) and list a second price and risk parameter when the first is violated (e.g., 25% offer with a max of 5000 vega, 26% offer with a max of 10,000 vega, and 27% offer with a max of 10,000 vega).

Once a bid or offer is triggered, the BOM system determines whether the order is locked by another transaction. In the event the order is locked, the BOM system may wait for the order to be released. In the event the order is released (e.g., the earlier trade is not executed, or a trade was executed and the books updated), the BOM system makes sure that the trade is still valid before locking the order of a subsequent trade. In the event the order is released or the order was not locked by another trade, the BOM system locks the bids and offers in the CSBs of the trader engaged in the trade and reserves the trade. The BOM system then determines that the conditions for the trade are met, including the availability of contingent trades. The BOM system confirms that the trade is still valid and executes the trade. Following execution of the trade, the BOM system recalculates all of the CSBs 284 of the trader by taking into account the executed trade and then releases the locked CSBs of the trader. The BOM system may include a release locked markets threshold 286 that specifies the amount of time a market may be locked, and release locked markets logic 288 that monitors the duration of the locks on the locked markets. When the duration of a lock on a market exceeds the release locked markets threshold 286, the release locked markets logic 288 may, in coordination with the lock (freeze) and reserve procedure, release the locked market.

The BOM system may also the use the lock (freeze) and reserve procedure to process a Request for Quote (RFQ) that a trader may request for a specific trade (e.g., outright or spread). After the trader requests the RFQ, the BOM system uses the lock (freeze) and reserve procedure to provide other traders a period of time to respond to the RFQ, negotiate, and execute the a trade.

The BOM system controls the locks on the bids and offers of a trader based on criteria determined by the trader's trading criteria. The BOM system may control the locks on the bids and offers of a trader based on criteria determined by the exchange. For example, the exchange may require locks on the bids and offers of a trader based on whether the rules of the trader's margin account would be violated in the event all of the potential markets of the trader were executed concurrently during the execution of a given trade. In the event the BOM system determines that the trader has the financial capacity to simultaneously honor all of the potential markets of the trader during the execution of a given trade, the BOM system may limit the locks to the bids and offers of the trader during the given trade to the bids and offers specifically involved with the given trade, so that the trader has the potential to realize more simultaneously executed trades. In contrast, the BOM system may lock all the bids and offers of a trader during any given trade, in the event the BOM system determines that the trader only possess the financial capacity to simultaneously honor a limited number of potential markets of the trader, during the execution of any given trade. The BOM system may limit the locks on the bids and offers of a trader based on any combination of PRM parameters, trading criteria or risk sensitivity measurements.

In another example, the BOM system may limit the locks placed on a trader's bids and offers only to an extent that the trader's risk parameters are not violated. In other words, the BOM system may allow any number of bids and offers of a trader to remain unlocked during a given trade, in the event the BOM system determines that the execution of all the potential markets of the trader during the execution of any given trade would not violate any of the risk parameters of the trader. For example, a trader may have a maximum vega bid risk variable of 20,000. In the event the BOM system determines that the simultaneous execution of the potential markets of a trader during the execution of a given trade would not exceed 18,000 vega, the BOM system may only lock the bids and offers involved in the given trade and allow the other bids and offers of the trader to remain unlocked.

The BOM system may include circuit breaker criteria that allow the BOM system to respond appropriately to conditions such as fast markets and rules used during the opening of trading and/or before an economic announcement with the potential to impact the markets. For example, the BOM system may exclude all conditional trading and limit trading to the ROB during a designated period when the exchange first opens trading, or circuit break criteria are met, or before the Federal Reserve or an industry announcement is made.

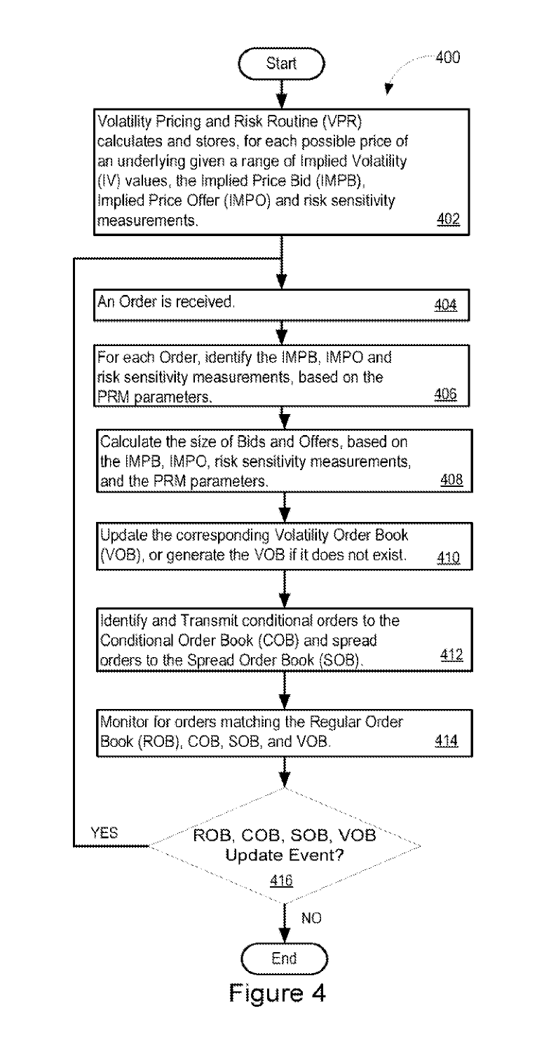

FIG. 4 shows the logic flow 400 the BOM system configuration may take to update the ROB, COB, SOB, and VOB. The BOM system includes logic to receive pricing and risk matrix (PRM) parameters from each trader, and generate and maintain corresponding order books for each trader for each trade class. In one implementation, the BOM system calculates trading criteria for each trader and transmits the trading criteria to one or more of the order books of the trader, based on the PRM parameters. The VPR logic 214 may calculate and transmit the implied price bid, the implied price offer, risk sensitivity measurements, and the size of each potential bid and offer to the VOB (402). In particular, the BOM system may transmit the trading criteria to one or more conditional order books. The BOM system monitors changes related to the trade classes, PRM parameters, trade criteria and the order books, and receives orders (404). The BOM system generates a volatility order book (VOB) for each trade class, and places conditional orders on the VOB. The BOM system uses the PRM parameters and trade criteria to analyze orders and determine which order books to transmit orders (406). Based on the PRM parameters, the BOM system calculates trading criteria for each trader including an implied price bid, an implied price offer, a size of a potential bid and offer using the implied price bid and offer and risk sensitivity measurements (408). The risk sensitivity measurements may include a price move of the underlying (delta measurement), an implied volatility move (vega measurement), a curvature of vega plotted graphically (gamma measurement), and a time decay of an option for the item being traded in the trade class (theta measurement). The BOM system receives and analyzes bids and offers from traders for multiple trade classes (404).

In one implementation, the BOM system includes COB logic 221 that generates the COB, and receives and processes conditional orders. Conditional orders may be based on one or more contingencies being true. The BOM system analyzes the number of contingencies on which a conditional order is based and determines the number of conditional orders that are concurrently pending for a given trader. The COB logic may match the bids and the offers to conditional orders on the COB, and monitor the contingencies to determine whether one of the contingencies evaluates to true. A contingency may be based on any combination of risk sensitivity measurements. In one implementation, the trader specifies the contingencies. In another implementation, the PRM parameters specify the contingencies.

The BOM system may also include SOB logic 222 that generates the SOB and receives and processes spread orders. In one implementation, the SOB logic analyzes a spread order for combinations of bids and offers that may satisfy the spread order, monitors the TOB to identify for each combination whether a conditional bid or a conditional offer can be generated to satisfy the spread order. The SOB logic generates and transmits the respective conditional bid or the conditional offer that can satisfy the spread order to the COB. The SOB logic transforms the spread order into a conditional spread order and validates that the conditional spread order is valid.

The BOM system applies allocation rules that determine how an order is allocated to bids and offers on the CSBs 284. The allocation rules may be provided by the exchange or other sources. Different allocation rules may be applied for different types of orders and for different types of orders on each order book. For example, orders with fewer contingencies may have a greater percentage of allocation. In one implementation, an exchange maintaining the BOM system may determine whether to display a TOB or individual order books to traders. In another implementation, each trader may determine whether a TOB or individual order books are displayed to the trader.

The BOM system generates order books for each trade class that a trader has indicated a desire to trade based on the PRM parameters. In one implementation, the BOM system updates the order books whenever a change occurs in the underlying market, a PRM change, and/or when a market is reserved for a given trader. The BOM system may use any number of risk parameters submitted by a trader, depending on the capacity of the BOM system and computing resources available to the BOM system. The VPR logic 214 calculates and transmits the implied price bid, the implied price offer, and the size of each potential bid and offer to the VOB. The VOBs (of each trader) are consolidated and the conditional orders are sent to the COB. The BOM system 100 may use the VPR logic 214 to constantly update the VOBs of each trader based on the lock (freeze) and reserve process.

For example, a trader (PMM) submits a PRM 224 to the BOM system 100 using a specific pricing model and variables (e.g., interest rates and IV). The VPR logic 214 calculates options prices and sizes using the model priced off of the current future's price. For example, call bids may be priced off of the current bid in the underlying. However, the trader may choose to use a different underlying such as the average of the last 3 trades and/or an offset of a different month's bid. Although the trader may have a position in many months and strikes, the trader may decide to only submit information and make markets in particular months and strikes. The trader may submit PRM parameters that assist the trader to hedge the trader's delta in the futures' market. The trader's markets are displayed in the COB. The COB matches a trade and the BOM system allocates a buy of a portion of the trade to a PMM. Assuming none of the markets of the PMM are locked, the trade is reserved and the conditional bids and offers of the PMM are locked. The BOM system, based on the reserved trade, adjusts the vega and the delta positions of the trader and PMM. In one implementation, the BOM system, according to the hedge instructions (e.g., sensitivity parameters) buys or sells futures to hedge delta risk depending on whether the trade decreases or increases, respectively, the delta position of the trader. Once a trade is executed, the PRM, trading criteria and sensitivity parameters of the trader may be adjusted, books are updated and the trader's books are unlocked.

In another example, where the futures price changes for an underlying, the current position of the PMM may not change. However, based on the change in price of the underlying, the BOM system recalculates the implied price bid, the implied price offer and the size of a potential bid and offer. The BOM system updates the VOB and COB. With the markets entered in the COB, a trade gets matched and the PMM is allocated a buy. In the event none of the markets of the PMM are locked, the trade is reserved. The bids and offers of the PMM are locked and the BOM system adjusts the vega and delta of the PMM and trader, based on the reserved trade. In one implementation, the BOM system, according to the hedge instructions (e.g., sensitivity parameters) buys or sells futures to hedge delta risk depending on whether the trade decreases or increases, respectively, the delta position of the trader (PMM).

The BOM system uses PRM parameters (PRM) to establish a number of trading criteria that a trader may desire to use to evaluate whether to engage in a particular trade. The number of variables used to establish the trading criteria for a trader may be limitless.

The Tables 1-19 below and the accompanying description for each table describe the actions the BOM system may take during operations. A PMM submits PRM parameters to an exchange that includes a specific pricing model and interest rate, and trading criteria that directs the exchange to calculate options prices and market sizes using the PMM's model priced off of the current Future's price. Although the PMM may have a position in many months and strikes, the PMM may decide to only submit information and make markets in the November 900 Call, the November 880 Put, and the November 1000 Call options. In addition, the PMM may use a front end set up to automatically hedge the PMM's delta in the Future's market. Table 1 shows the PMM's IVB and IVA and Table 2 illustrates the risk parameters that the PMM may have submitted.

TABLE 1
PMM's IVB and IVA

| Option Class | IVB (%) | IVA (%) |
|---|---|---|
| November 880 Put | 26.8 | 27.8 |
| November 900 Call | 27.2 | 28.2 |
| November 1000 Call | 29.5 | 30.5 |

TABLE 2
Risk Parameters

| Risk Parameter | Long | Short |
|---|---|---|
| Maximum Vega Per Trade | 8,000 | −8,000 |
| Maximum Vega Per Strike | 20,000 | −20,000 |
| Maximum Vega Per Month | 12,000 | −10,000 |
| Maximum Delta Per Trade | 75.00 | −75.00 |

Table 3 shows the current portfolio risk sensitivity levels for the PMM.

TABLE 3
Risk Sensitivity Parameters

| | |
|---|---|
| Vega at 880 Strike | −3,000 |
| Vega at 900 Strike | −3,000 |
| Vega at 1000 Strike | +4,000 |
| Total November Vega | −6,600 |
| Total Delta | +2.60 |

Tables 4 shows the hedge table that may be calculated based on the PRM, risk sensitivity and trading criteria provided by the PMM.

TABLE 4
Hedge Table Pre-Trade

| Future at 900 | IV | T.V. | Vega | Delta |
|---|---|---|---|---|
| Nov 880 Put | 26.8 IVB | 23.75 | 59 | −.30 |
| Nov 880 Put | 27.8 IVA | 25.00 | 59 | −.30 |
| Nov 900 Call | 27.2 IVB | 33.75 | 62 | .52 |
| Nov 900 Put | 28.2 IVA | 35.00 | 62 | .52 |
| Nov 1000 Call | 29.5 IVB | 7.75 | 39 | .17 |
| Nov 1000 Call | 30.5 IVA | 8.50 | 39 | .17 |

Table 5 shows the potential market sizes for the 880 Puts 23.75 Bid and 25.00 Offer. Consequently, a 23.75 Bid for 135 Contracts and an Offer at 25.00 for 57 Contracts for the November 880 Puts are transmitted to the VOB and then the COB. Note the system may use the smallest quantity of the calculated permutations.

TABLE 5
Market Size for 880 Puts

| | Max | Existing | Available | Contracts |
|---|---|---|---|---|
| Max Long Vega Per | 8,000 | N/A | 8,000 | 135 |
| Trade | | | | |
| Max Long Vega Per | 20,000 | −3,000 | 23,000 | 389 |
| Strike | | | | |
| Max Long Vega Per | 12,000 | −6,600 | 18,400 | 311 |
| Month | | | | |
| Max Short Delta Per | −75.00 | 2.60 | −77.6 | 258 |
| Trade | | | | |
| Max Short Vega Per | −8,000 | N/A | −8,000 | 135 |
| Trade | | | | |
| Max Short Vega Per | −20,000 | −3,000 | −17,000 | 288 |
| Strike | | | | |
| Max Short Vega Per | −10,000 | −6,600 | −3,400 | 57 |
| Month | | | | |
| Max Long Delta Per | 75.00 | 2.60 | 72.40 | 241 |
| Trade | | | | |

Table 6 shows the potential market sizes for the 900 Calls 33.75 Bid and 35.00 Offer. Consequently, a 33.75 Bid for 128 Contracts and an Offer at 35.00 for 54 Contracts for the November 900 Calls are transmitted to the VOB and then the COB.

TABLE 6
Market Size Analysis for 900 Calls

| | Max | Existing | Available | Contracts |
|---|---|---|---|---|
| Max Long Vega Per | 8,000 | N/A | 8,000 | 128 |
| Trade | | | | |
| Max Long Vega Per | 20,000 | −3,000 | 23,000 | 370 |
| Strike | | | | |
| Max Long Vega Per | 12,000 | −6,600 | 20,200 | 295 |
| Month | | | | |
| Max Long Delta Per | 75.00 | 2.60 | 72.40 | 139 |
| Trade | | | | |
| Max Short Vega Per | −8,000 | N/A | −8,000 | 128 |
| Trade | | | | |
| Max Short Vega Per | −20,000 | −3,000 | −17,000 | 274 |
| Strike | | | | |
| Max Short Vega Per | −10,000 | −6,600 | −3,400 | 54 |
| Month | | | | |
| Max Short Delta Per | −75.00 | 2.60 | −77.60 | 149 |
| Trade | | | | |

Table 7 shows the potential market sizes for the 1000 Calls 7.75 Bid and 8.50 Offer. Consequently, a 7.75 Bid for 205 Contracts and an Offer at 8.50 for 87 Contracts for the November 1000 Calls are transmitted to the VOB and then the COB.

TABLE 7
Market Size Analysis for 1000 Calls

| | Max | Existing | Available | Contracts |
|---|---|---|---|---|
| Max Long Vega Per | 8,000 | N/A | 8,000 | 205 |
| Trade | | | | |
| Max Long Vega Per | 20,000 | 4,000 | 16,000 | 410 |
| Strike | | | | |
| Max Long Vega Per | 12,000 | −6,600 | 18,400 | 471 |
| Month | | | | |
| Max Long Delta Per | 75.00 | 2.60 | 72.40 | 425 |
| Trade | | | | |
| Max Short Vega Per | −8,000 | N/A | −8,000 | 205 |
| Trade | | | | |
| Max Short Vega Per | −20,000 | 4,000 | 24,000 | 615 |
| Strike | | | | |
| Max Short Vega Per | −10,000 | −6,600 | −3,400 | 87 |
| Month | | | | |
| Max Short Delta Per | −75.00 | 2.60 | −77.60 | 456 |
| Trade | | | | |

Given the markets shown in the COB, the BOM system matches a trade matched and the PMM is allocated a buy of 100 November 900 Calls. Since none of PMM's markets are locked, the trade is reserved, the PMM's bids and offers are locked and the VOB logic makes the following adjustments, based on the reserved traded: the Vega of the 900 strike increases by 6,200; and the delta of the position increases by 52.00. Based on the instructions submitted by the PMM to hedge the Futures, the BOM system or the PMM's front end will sell 52 Futures to hedge the delta risk. The trade then takes place. Following the trade, the books of the trader will be adjusted, and the trader's markets will be unlocked. Table 8 illustrates the PMM's portfolio following the trade.

TABLE 8
PMM Portfolio Post-Trade

| | |
|---|---|
| Vega at 880 Strike | −3,000 |
| Vega at 900 Strike | +3,200 |
| Vega at 10000 Strike | +4,000 |
| Total November Vega | +400 |
| Total Delta | +2.60 |

Tables 9-11 illustrate the potential market sizes for the 880 Puts, 900 Calls, and 1000 Calls, following the trade. Observe that the bid and offer prices in the VOB and COB do not change but the sizes change to the following: 880 Put—135×135; 900 Call—128×128; and 1000 Call—205×205.

TABLE 9
Market Sizes for 880 Put Post-Trade

| 880 Put | Max | Existing | Available | Contracts |
|---|---|---|---|---|
| Max Long Vega Per | 8,000 | N/A | 8,000 | 135 |
| Trade | | | | |
| Max Long Vega Per | 20,000 | −3,000 | 23,000 | 389 |
| Strike | | | | |
| Max Long Vega Per | 12,000 | +400 | 11,600 | 196 |
| Month | | | | |
| Max Short Delta Per | −75.00 | 2.60 | −77.6 | 258 |
| Trade | | | | |
| Max Short Vega Per | −8,000 | N/A | −8,000 | 135 |
| Trade | | | | |
| Max Short Vega Per | −20,000 | −3,000 | −17,000 | 288 |
| Strike | | | | |
| Max Short Vega Per | −10,000 | +400 | −10,400 | 176 |
| Month | | | | |
| Max Long Delta Per | 75.00 | 2.60 | 72.40 | 241 |
| Trade | | | | |

TABLE 10
Market Sizes for 900 Call Post-Trade

| 900 Call | Max | Existing | Available | Contracts |
|---|---|---|---|---|
| Max Long Vega Per | 8,000 | N/A | 8,000 | 128 |
| Trade | | | | |
| Max Long Vega Per | 20,000 | +3,200 | 16,800 | 270 |
| Strike | | | | |
| Max Long Vega Per | 12,000 | +400 | 11,600 | 187 |
| Month | | | | |
| Max Long Delta Per | 75.00 | 2.60 | 72.40 | 139 |
| Trade | | | | |
| Max Short Vega Per | −8,000 | N/A | −8,000 | 128 |
| Trade | | | | |
| Max Short Vega Per | −20,000 | 3,200 | 23,200 | 374 |
| Strike | | | | |
| Max Short Vega Per | −10,000 | +400 | −10,400 | 167 |
| Month | | | | |
| Max Short Delta Per | −75.00 | 2.60 | −77.60 | 149 |
| Trade | | | | |

TABLE 11
Market Sizes for 1000 Call Post-Trade

| 1000 Call | Max | Existing | Available | Contracts |
|---|---|---|---|---|
| Max Long Vega Per | 8,000 | N/A | 8,000 | 205 |
| Trade | | | | |
| Max Long Vega Per | 20,000 | 4,000 | 16,000 | 410 |
| Strike | | | | |
| Max Long Vega Per | 12,000 | +400 | 11,600 | 297 |
| Month | | | | |
| Max Long Delta Per | 75.00 | 2.60 | 72.40 | 425 |
| Trade | | | | |
| Max Short Vega Per | −8,000 | N/A | −8,000 | 205 |
| Trade | | | | |
| Max Short Vega Per | −20,000 | 4,000 | 24,000 | 615 |
| Strike | | | | |
| Max Short Vega Per | −10,000 | +400 | −10,400 | 266 |
| Month | | | | |
| Max Short Delta Per | −75.00 | 2.60 | −77.60 | 456 |
| Trade | | | | |

Suppose that no trades take place, but the Futures price changes from 900 to 908. The current position has not changed so the Portfolio from above shown in Table 8 remains and the VOB logic recalculates the price and size of each market as shown in Table 12.

TABLE 12
Hedge Table Post-Trade

| Future at 908 | IV | T.V. | Vega | Delta |
|---|---|---|---|---|
| Nov 880 Put | 26.8 IVB | 21.00 | 58 | −.35 |
| Nov 880 Put | 27.8 IVA | 22.25 | 58 | −.35 |
| Nov 900 Call | 27.2 IVB | 38.00 | 62 | .55 |
| Nov 900 Put | 28.2 IVA | 39.25 | 62 | .55 |
| Nov 1000 Call | 29.5 IVB | 9.00 | 43 | .19 |
| Nov 1000 Call | 30.5 IVA | 10.00 | 43 | .19 |

Tables 13-15 show the recalculated potential market sizes for the 880 Puts, 900 Calls and 1000 Calls.

TABLE 13
Market Sizes for 880 Puts

| 880 Put | Max | Existing | Available | Contracts |
|---|---|---|---|---|
| Max Long Vega Per | 8,000 | N/A | 8,000 | 137 |
| Trade | | | | |
| Max Long Vega Per | 20,000 | −3,000 | 23,000 | 395 |
| Strike | | | | |
| Max Long Vega Per | 12,000 | +400 | 11,600 | 199 |
| Month | | | | |
| Max Short Delta Per | −75.00 | 2.60 | −77.6 | 221 |
| Trade | | | | |
| Max Short Vega Per | −8,000 | N/A | −8,000 | 137 |
| Trade | | | | |
| Max Short Vega Per | −20,000 | −3,000 | −17,000 | 292 |
| Strike | | | | |
| Max Short Vega Per | −10,000 | +400 | −10,400 | 179 |
| Month | | | | |
| Max Long Delta Per | 75.00 | 2.60 | 72.40 | 206 |
| Trade | | | | |

TABLE 14
Market Sizes for 900 Calls

| 900 Call | Max | Existing | Available | Contracts |
|---|---|---|---|---|
| Max Long Vega Per | 8,000 | N/A | 8,000 | 128 |
| Trade | | | | |
| Max Long Vega Per | 20,000 | +3,200 | 16,800 | 270 |
| Strike | | | | |
| Max Long Vega Per | 12,000 | +400 | 11,600 | 187 |
| Month | | | | |
| Max Long Delta Per | 75.00 | 2.60 | 72.40 | 131 |
| Trade | | | | |
| Max Short Vega Per | −8,000 | N/A | −8,000 | 128 |
| Trade | | | | |
| Max Short Vega Per | −20,000 | 3,200 | 23,200 | 374 |
| Strike | | | | |
| Max Short Vega Per | −10,000 | +400 | −10,400 | 167 |
| Month | | | | |
| Max Short Delta Per | −75.00 | 2.60 | −77.60 | 141 |
| Trade | | | | |

TABLE 15
Market Sizes for 1000 Calls

| 1000 Call | Max | Existing | Available | Contracts |
|---|---|---|---|---|
| Max Long Vega Per | 8,000 | N/A | 8,000 | 186 |
| Trade | | | | |
| Max Long Vega Per | 20,000 | 4,000 | 16,000 | 372 |
| Strike | | | | |
| Max Long Vega Per | 12,000 | +400 | 11,600 | 269 |
| Month | | | | |
| Max Long Delta Per | 75.00 | 2.60 | 72.40 | 381 |
| Trade | | | | |
| Max Short Vega Per | −8,000 | N/A | −8,000 | 186 |
| Trade | | | | |
| Max Short Vega Per | −20,000 | 4,000 | 24,000 | 558 |
| Strike | | | | |
| Max Short Vega Per | −10,000 | +400 | −10,400 | 241 |
| Month | | | | |
| Max Short Delta Per | −75.00 | 2.60 | −77.60 | 408 |
| Trade | | | | |

The number of variables used to establish the trading criteria for a trader may be limitless. Based on the calculated price and size of each market, the VOB and COB are changed to: 880 Puts—21.00 Bid for 137 Contracts: 137 Contracts Offered at 22.25; 900 Calls—38.00 Bid for 128 Contracts: 128 Contracts Offered at 39.25; and 10000 Calls: 9.00 Bid for 186 Contracts: 186 Contracts Offered at 10.00. Using market information in the COB, a trade gets matched and PMM gets allocated a buy of 150 November 1000 Calls and since none of PMM's markets are locked, the trade is reserved, the PMM's bids and offers are locked, and the VOB logic makes the following adjustments based on the reserved trade: the Vega of the 1000 strike increases by +6,450; and the delta of the position increases by 28.50. Given the instructions submitted by the PMM to hedge the Futures, the BOM system or the trader's front end sells 29 Futures to hedge the delta risk. Consequently, the PMM's portfolio will be as shown in Table 16.

TABLE 16
PMM Portfolio

| | |
|---|---|
| Vega at 880 Strike | −3,000 |
| Vega at 900 Strike | +3,200 |
| Vega at 10000 Strike | +10,450 |
| Total November Vega | +6,850 |
| Total Delta | +2.10 |

Table 17-19 illustrate that the bid and offer prices in the VOB and COB do not change but the sizes change to: 880 Put—88×135; 900 Call—83×128; and 1000 Call—119×205.

TABLE 17
Market Sizes for 880 Puts

| 880 Put | Max | Existing | Available | Contracts |
|---|---|---|---|---|
| Max Long Vega Per | 8,000 | N/A | 8,000 | 135 |
| Trade | | | | |
| Max Long Vega Per | 20,000 | −3,000 | 23,000 | 389 |
| Strike | | | | |
| Max Long Vega Per | 12,000 | +6,850 | 5,150 | 88 |
| Month | | | | |
| Max Short Delta Per | −75.00 | 2.10 | −77.10 | 220 |
| Trade | | | | |
| Max Short Vega Per | −8,000 | N/A | −8,000 | 135 |
| Trade | | | | |
| Max Short Vega Per | −20,000 | −3,000 | −17,000 | 288 |
| Strike | | | | |
| Max Short Vega Per | −10,000 | +6,850 | −16,850 | 290 |
| Month | | | | |
| Max Long Delta Per | 75.00 | 2.10 | 72.90 | 208 |
| Trade | | | | |

TABLE 18
Market Sizes for 900 Call

| 900 Call | Max | Existing | Available | Contracts |
|---|---|---|---|---|
| Max Long Vega Per | 8,000 | N/A | 8,000 | 128 |
| Trade | | | | |
| Max Long Vega Per | 20,000 | +3,200 | 16,800 | 270 |
| Strike | | | | |
| Max Long Vega Per | 12,000 | +6,850 | 5,150 | 83 |
| Month | | | | |
| Max Long Delta Per | 75.00 | 2.10 | 72.90 | 132 |
| Trade | | | | |
| Max Short Vega Per | −8,000 | N/A | −8,000 | 128 |
| Trade | | | | |
| Max Short Vega Per | −20,000 | 3,200 | 23,200 | 374 |
| Strike | | | | |
| Max Short Vega Per | −10,000 | +6,850 | −16,850 | 271 |
| Month | | | | |
| Max Short Delta Per | −75.00 | 2.10 | −77.10 | 140 |
| Trade | | | | |

TABLE 19
Market Sizes for 1000 Call

| 1000 Call | Max | Existing | Available | Contracts |
|---|---|---|---|---|
| Max Long Vega Per | 8,000 | N/A | 8,000 | 205 |
| Trade | | | | |
| Max Long Vega Per | 20,000 | 10,450 | 9,550 | 222 |
| Strike | | | | |
| Max Long Vega Per | 12,000 | +6,850 | 5,150 | 119 |
| Month | | | | |
| Max Long Delta Per | 75.00 | 2.10 | 72.90 | 383 |
| Trade | | | | |
| Max Short Vega Per | −8,000 | N/A | −8,000 | 205 |
| Trade | | | | |
| Max Short Vega Per | −20,000 | 10,450 | −30,450 | 725 |
| Strike | | | | |
| Max Short Vega Per | −10,000 | +6,850 | −16,850 | 391 |
| Month | | | | |
| Max Short Delta Per | −75.00 | 2.10 | −77.10 | 405 |
| Trade | | | | |

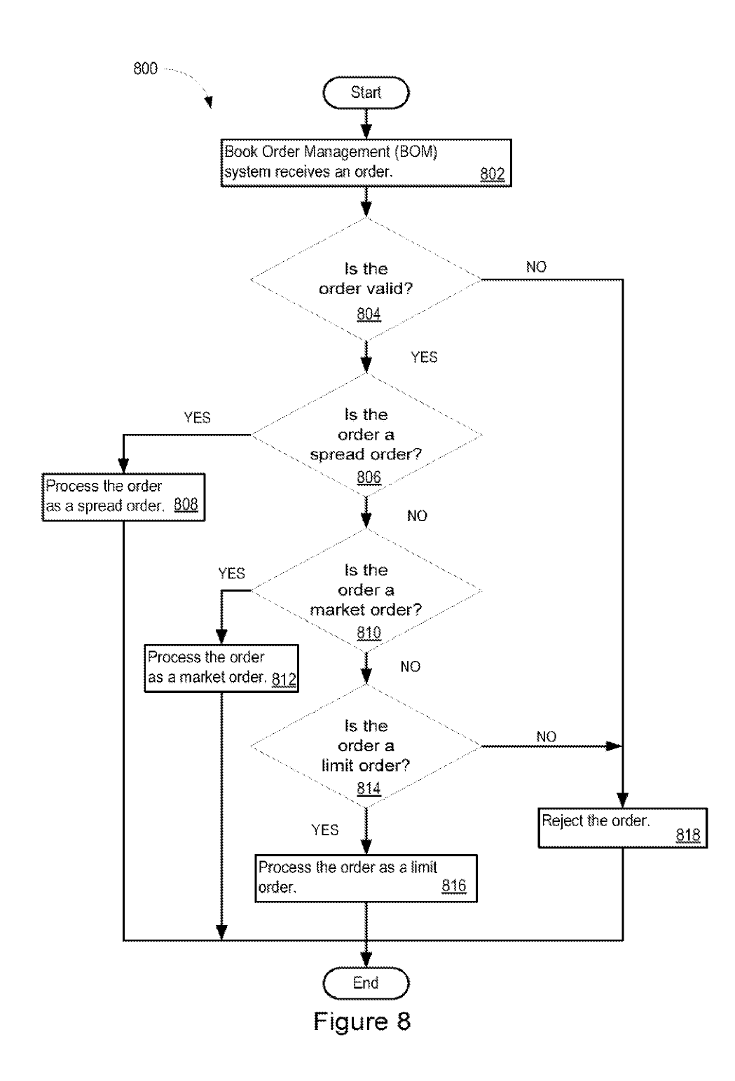

FIG. 8 illustrates the logic flow the BOM system may take to perform the order process when an order to buy or sell is received (802). The BOM system validates the order (804). In one implementation, the BOM system may determine the validity of an order based on a credit check of the trader submitting the order. The BOM system may evaluate whether the order is a spread order (806) and establish that the order is a spread order and process the order as a spread order (808), which will be discussed in detail below. In the event the BOM system determines that the order is not a spread order, the BOM system may evaluate whether the order is a market order (810), and establishes that the order is a market order and process the order as a market order (812), which will be discussed in detail below. In the event the BOM system determines that the order is not a market order, the BOM system may evaluate whether the order is a limit order (814), and establishes that the order is a limit order and process the order as a limit order (816). In the event the BOM system determines that the order is not valid, the BOM system may reject the order (818).

In one implementation, the BOM system transmits each market order to the trade allocation logic to trade at the best available price. The BOM system transmits a limit sell order to the ROB, where the BOM system determines that a current offer on the TOB is less than the price of the limit sell order. The BOM system adds the limit sell order to the current offer on the ROB, where the current offer on the TOB is equal to the price of the limit sell order. The BOM system transmits the limit sell order to the trade allocation routine, where the current bid on the TOB is greater than or equal to the price of the limit sell order. The BOM system transmits the limit sell order to the ROB and the limit sell order becomes the current offer on the ROB, where the current bid on the TOB is less than the price of the limit sell order.

For example, the current market in the TOB may reflect a 7 bid and a 9 offer, when the BOM system receives a limit sell order to sell at 8. The BOM system determines that the current offer is not less than 8 (the limit sell order), the offer on the TOB is not equal to the order price, and the bid on the TOB is not greater than or equal to the order price (the limit sell order). The BOM system transmits the order to the ROB and the limit sell order becomes the current offer on the ROB. The BOM system updates the TOB so that the current market displayed on the TOB is a 7 Bid and 8 Offer. In another example, the current market in the TOB may reflect an 8 bid and a 9 offer, when the BOM system receives an order to sell at 8. The BOM system determines that the current offer is not less than 8, the offer on the TOB is not equal to the order price, but the bid on the TOB is greater than or equal to the order price. The BOM system transmits the order to the trade allocation logic to execute the trade.

The BOM system transmits a limit buy order to the ROB, where the BOM system determines that a current bid on the TOB is greater than the price of the limit buy order. The BOM system adds the limit bid order to the current bid on the ROB, where the current bid on the TOB is equal to the price of the limit bid order. The BOM system transmits the limit bid order to the trade allocation routine, where the current bid on the TOB is less than or equal to the price of the limit bid order. The BOM system transmits the limit bid order to the ROB and the limit sell order becomes the current bid on the ROB, where the current bid on the TOB is less than the price of the limit bid order.

For example, the current market in the TOB may reflect a 7 bid and a 9 offer, when the BOM system receives a limit buy order to buy at 8. The BOM system determines that the current bid is not greater than 8 (limit buy order), the bid on the TOB is not equal to the order price, and the offer on the TOB is not less than or equal to the order price. The BOM system transmits the limit buy order to the ROB and the limit buy order becomes the current bid. The BOM system updates the TOB so that the current market displayed on the TOB is an 8 bid and 9 offer. In another example, the current market in the TOB may reflect a 7 bid and an 8 offer, when the BOM system receives an order to buy at 8 comes. The BOM system determines that the current bid is not greater than 8, the bid on the TOB is not equal to the order price, but the offer on the TOB is less than or equal to the order price. The BOM system transmits the order to the trade allocation logic to execute the trade.

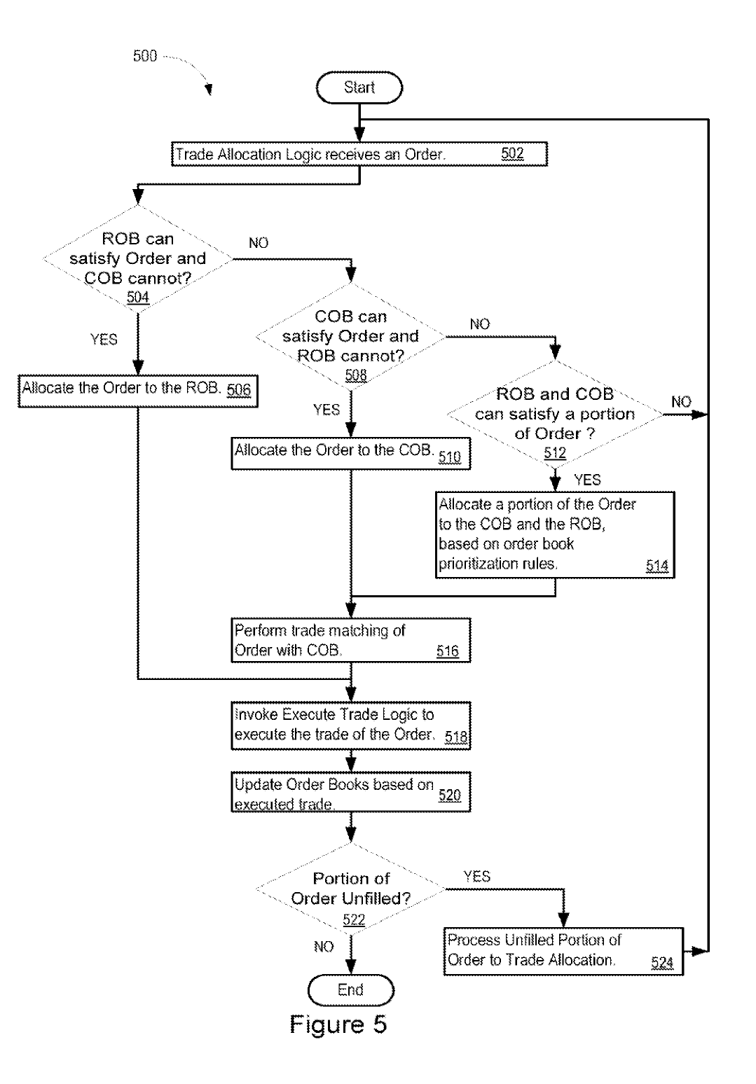

FIG. 5 shows the logic flow 500 the BOM system configuration may take to perform trade allocation when an order is received. The trade allocation logic receives orders (502) and evaluates whether an order can be satisfied by the ROB that cannot be satisfied by the COB (504), and whether the order can be satisfied by the COB that cannot be satisfied by the ROB (508). The trade allocation logic decomposes the order into multiple sub-orders and the multiple sub-orders include multiple portions. The trade allocation logic evaluates whether the ROB and the COB can satisfy one or more portions of the order (512). The trade allocation logic allocates the order to the ROB, where the ROB can satisfy the order and the COB cannot satisfy the first order (506). The trade allocation logic allocates the order to the COB, where the COB can satisfy the order and the ROB cannot satisfy the order (510). The trade allocation logic allocates a portion of the order to the ROB and a portion of the order to the COB, where the ROB and the COB can satisfy a portion the order (514). The trade allocation logic invokes the execute trade logic to execute a trade of the order, where the order or a portion of the order has been allocated. The trade allocation logic allocates a portion of the order to the ROB and the COB, where the ROB and the COB can equally satisfy a portion of the order, based on order book prioritization rules (518). In one implementation, the order book prioritization rules may be established by the administrator of the BOM system (e.g., an exchange). For example, the exchange may have different allocation rules and preferences for non-conditional markets. In another implementation, the BOM system may determine prioritization rules based on historical trading activity and/or information external to the BOM system. Once the order is executed the order books are updated based on the trade (520), trade allocation logic determines whether a portion of the order was not traded (522), and the balance of unfilled portion of the order is processed by the trade allocation logic (524). When the unfilled portion of the order is processed by the trade allocation logic a first time and remains unfilled a second time then the unfilled portion is returned to the originating order books.

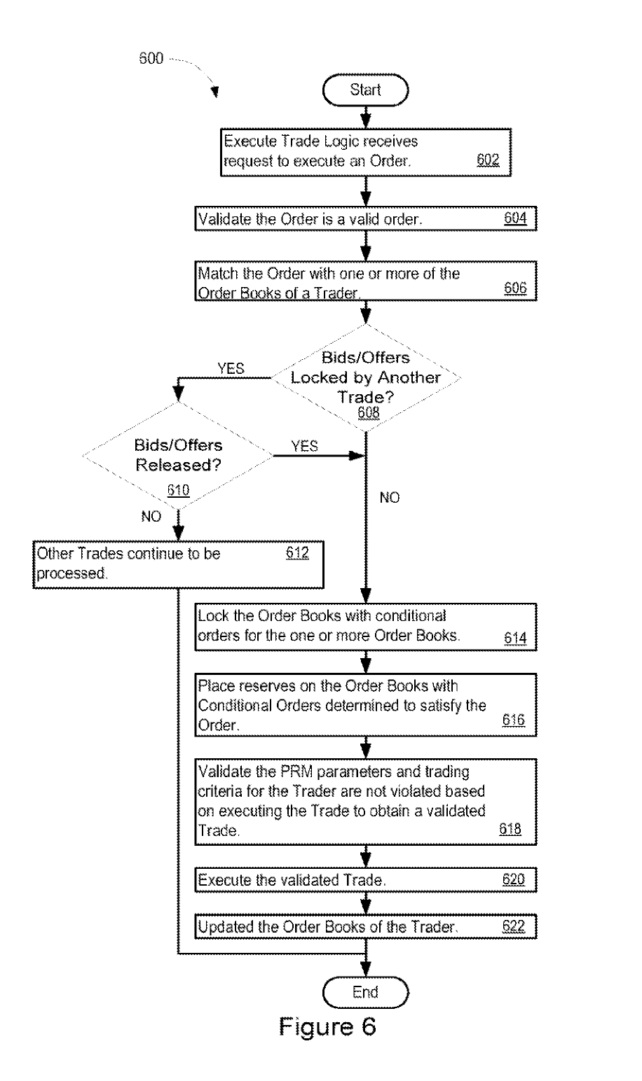

FIG. 6 illustrates the logic flow 600 that the BOM system configuration may take to execute a trade. In one implementation, the execute trade logic receives requests to execute trades with orders corresponding to particular trade classes (602). The execute trade logic validates the order (602), and matches the order with one or more order books of a trader (604). The execute trade logic determines whether the bids or offers matching the order are locked by a trade (608). When the bids or offers matching the order are locked, the execute trade logic monitors for whether the bids or offers matching the order are unlocked (release) (610). The BOM system may include a release locked bid or offer threshold that specifies the amount of time a bid or offer may be locked. The execute trade logic, or the BOM system may include release locked bid or offer logic that monitors the duration of the locks on the locked bids and offers. When the duration of a lock on a bid or offer exceeds the release locked bid or offer threshold, the release locked bid or offer logic, in coordination with the lock (freeze) and reserve procedure, releases the locked bid or offer. The execute trade logic continues to process and/or completes other trades (612) while the bids or offers matching the order are locked.

When the execute trade logic determines that the bids or offers matching the order are not locked (608), the execute trade logic locks those order books that include a conditional order that matches the bids or offers (614). The execute trade logic places reserves on the order books with conditional orders that have been determined to satisfy the order (616). The execute trade logic validates that the PRM parameters and trading criteria for the trader are not violated, in the event the trade is executed, in order to obtain a validated trade (618). The execute trade logic executes the validated trade with the trader and updates the order books of the trader, based on the executed trade (620).

In the event the execute trade logic determines that the trade is a conditional trade contingent on another trade, the execute trade logic generates a conditional order to leg the other trade. Legging the other trade includes generating a conditional order for the other trade and transmitting the conditional order to the trade allocation logic. In one implementation, the execute trade logic updates order books (622) that are not involved in a given trade based on preferences set by the trader in the PRM parameters and/or preferences set by the BOM system. After the trade is executed and the books are updated, the trader's books are unfrozen. When an unfilled portion of an order is processed by the execute trade logic a first time and remains unfilled a second time then the unfilled portion is returned to the originating order books.

The BOM system may use different allocation rules for non conditional markets and may give priority to traders that have a market that is non-conditional. The BOM system may allocate trades based on time priority (e.g., FIFO), prorated based on the size of the offer, membership class of the trader, and/or criteria established by an exchange in which the BOM system is used. For example, the trade allocation logic may allocate a percent of an order to traders with the best offer on the ROB, and the balance of the order may be distributed to the traders with the best offer on the COB.

For example, the Exchange may decide that the ROB is entitles to 50% of a trade based on FIFO and that the balance is distributed to traders on the COB based on a prorated basis as a percentage of the trader's share of the bid. Where three traders bid for 50, 100, 250, respectively, the allocation may be calculated to be 12.5%, 25%, and 62.5% of the order, respectively. The trade allocation logic receives an order to sell 100 options contracts at a price of 8, where both the COB and ROB can satisfy the order. The trade allocation logic may allocate 50% of the trade to the ROB so that 50 contracts are allocated and executed on the ROB on a FIFO basis. The balance of the 50 contracts may be allocated to the COB and distributed to traders on the COB, based on a percentage share of the bid, so that where the traders have bids of 50, 100, 250 then the allocation would be 6, 13, and 31 contracts respectively to each trader on the COB. In one implementation, the trade allocation logic receives an order to sell 100 options at a price of 8, where there is only a bid on the COB that satisfies the order. The trade allocation logic allocates all 100 contracts to the COB and distributes the contracts to the traders on the COB, based on the trader's percentage share of the bid. For example, where three traders each bid for 50, 100, and 250, respectively, the allocation may be 12, 25, and 63 to each of trader.

When an order to buy or sell a spread is received by the BOM system, the validity of the order is determined. In one implementation, the BOM system may determine the validity of an order based on a credit check of the trader submitting the order. The BOM system may determine that the order is a limit or market order. In the event the BOM system determines that the order is a market order, the BOM system analyzes whether the spread can be “legged” in the TOB. The BOM system calculates the value of the legged spread for all traders based on the PRM parameters submitted by each respective trader and determines whether the spread is tradable in the SOB. The BOM system selects the most advantageous way to satisfy the order so that the order receives the best price.

The BOM system may route the spread order to leg the trade, in which case the BOM system creates market orders for each leg. The BOM system may allocate the spread to multiple traders, based on the trading criteria and PRM parameters, and/or allocation rules established by the exchange. In the event a portion of a spread order is not completed, the BOM system attempts to process the balance of the spread order until the entire spread order has been executed. All legs may be executed using the freeze and reserve process.

The BOM system may receive a limit spread order and determines whether the spread order is tradable with the SOB. The SOB logic may calculate the value of the legged spread against each of the trading criteria of each trader to identify one or more traders that can participate in executing the trade. In one implementation, the VOB logic determines whether the VOB can satisfy the spread order. The spread order is placed on the SOB, in the event a trader or combination of traders is not identified with whom the spread order can be traded. In the event the SOB logic determines that the spread order is tradable with the SOB, the BOM system compares the value of the legs based on the trading criteria of the traders involved in the trade and determines whether to execute the spread order on the SOB or the VOB based which of the two, the SOB or the VOB, provides the best price for the spread order.

For example, the BOM system receives a spread order to buy November 900 Calls and sell November 1000 Calls for a debit of 10. The SOB logic determines whether an offer of 10 or lower in the November 900-1000 call spread exists. The SOB logic identifies an offer of 9.75 in the SOB. The VOB logic analyzes the 900-1000 call spread value using the VOBs of each trader and legging TOB and determines that the best implied offer is 10. Consequently, the BOM system trades the spread order in the SOB.

Where a spread order cannot be satisfied by the SOB, the SOB logic may monitor the TOB to identify whether a conditional bid or a conditional offer can be generated to satisfy the spread order. For example, the BOM system receives a spread order to buy 900-920 call spread at 14, where the markets exist of: 900 call 23 bid and 25 offer; and 920 call 10 bid and 10.5 offer. The SOB logic determines that the SOB cannot satisfy the spread order, but a conditional bid of 24 in the 900 call based on the 10 bid in the 920 calls can be generated to satisfy the spread order. The SOB logic generates and transmits the respective conditional bid to the COB. The SOB logic transforms the spread order into a conditional spread order and validates that the conditional spread order is valid.

In one implementation, the execute trade logic receives requests to execute trades based on one or more legs of a spread order. Legs of a spread are reserved and the execute trade logic determines whether the legs of the spread are locked. If any of the legs are locked, the execute trade logic waits for release of the legs. Once the legs of a spread order are released, the execute trade logic transmits the spread order to the SOB where the spread order cannot be legged. The execute trade logic reserves the legs of the spread order and locks all of the bids and offers on the CSB's of the traders involved in the trade. The execute trade logic recalculates the CSBs for the traders based on the execution of the reserved trades to confirm that the trading criteria and PRM parameters are not violated, in the event the trade is executed to obtain a validate trade. The execute trade logic executes that validated trade and unlocks the locks all of the bids and offers on the COB of the traders involved in the trade. The balance of the spread order that is not traded is transmitted to the SOB.

For example, the execute trade logic attempts to reserve a 900 call offer at 24 and a 1000 call bid of 15.50. The execute trade logic determines that the legs of the spread order on the SOB are currently locked. The execute trade logic waits for legs of the spread to be released, and upon release, determines whether the spread order can be legged at 9.50. In the event the execute trade logic determines that the spread order cannot be legged, the legs are released. Otherwise, the execute trade logic reserves the 900 Call offer at 24 and the 1000 Bid at 15.50. The execute trade logic locks the bids and offers that are contingent on the reserved trades an d recalculates the CSBs of the traders involved in the spread leg trades based on the reserved trade being executed. The execute trade logic executes trade by legging the spread at 9.50 and unlocks the locked markets of the traders involved in the trade. The execute trade logic determines whether the order is filled and adjusts the balance of the spread order on the SOB.

The BOM system may receive a sell order and attempt to match the order with a specific conditional bid of a trader. For example, a trader may be allocated 10 call options to buy. The call options may be bids based on information in the VOB. The execute trade logic determines whether the bid is currently locked due to a different trade attempting to trade with the bid and reserves the bid for execution. The other bids and offers of the trader are frozen in the CSB's, and both the VOB logic and COB logic re-calculate the CSB's, as though the reserved trade executed to validate the trade and confirm that the trading criteria and/or the PRM parameters of the trader are not violated by the actual execution of the trade. The execute trade logic executes the order to buy 10 call options trade, in the event the trading criteria and/or PRM parameters are not violated by the trade. The execute trade logic transmits a confirmation that the trade executed successfully, and the CSB's are updated based on the executed trade. For example, the bids and offers on the VOB, SOB and COB (e.g., the CSBs) are updated and the CSBs of the trader involved in the trade are released. In another example, a trader may be allocated 10 call options to buy. The execute trade logic determines whether the bid is currently locked and waits for the bid to be released. Once the bid is released, the execute trade logic determines that the bid is no longer available and the 10 options to sell are transmitted to the BOM system as received orders. In the event, the PRM parameters are violated, the BOM system may execute a limited quantity of the trade that does not exceed PRM parameters, and the BOM system allows the trader to specify whether they want the system to fill partial orders.

In one implementation, a trader desires to buy a 900-920 call spread at 10 and the BOM system has generated a bid of 24 on the 900 calls in the COB based on the fact that there is a 14 bid in the 1000 calls. The trader may be allocated 10 900 call options to buy in the 900 calls. The execute trade logic may determine that the trader's bid in the 900 calls is not locked and lock the bids and offers of the trader in the CSBs. The execute trade logic may reserve the bid to buy the 900 calls at 24 and transmit an order to the BOM system to sell 10 1000 calls at 14 fill or kill (FOK). The execute trade logic may receive confirmation that the 1000 calls were sold and subsequently execute the reserved trade (buy the 900 calls at 24). The CSBs of the trader are recalculated by the COB logic, SOB logic and VOB logic for the respective CSBs, and the lock is released on the trader's bids and offers. In the example above, the order to sell 1000 calls at 24 and the trader's bid to buy the 900-1000 call spread at 10 were satisfied by the BOM system.

The BOM system may receive a buy order and attempt to match order with a specific conditional offer of a trader. For example, a trader may desire to sell the 900-920 call spread at 10 and the BOM system has generated an offer of 24 on the 900 calls in the COB based on the fact that there is a 14 offer in the 1000 calls. The trader may be allocated 10 900 call options to sell in the 900 calls. The execute trade logic may determine that the trader's offer in the 900 calls is not locked and lock the bids and offers in the CSBs of the trader. The execute trade logic may reserve the offer to sell 10 900 calls at 24 and transmits an order to the BOM system to buy 10 1000 calls at 14 FOK. The execute trade logic may receive confirmation that the 1000 calls were bought and subsequently execute the reserved trade (sell the 900 calls at 10). The CSBs of the trader are recalculated by the COB logic, SOB logic and VOB logic for the respective CSBs, and the locks are released on the trader's bids and offers on the CSBs. In the example above, the order to buy 1000 calls at 24 and trader's offer to sell the 900-1000 call spread at 10.

The BOM system may transmit a contingent order to the COB. Contingent orders may be generated by the VOB logic and SOB logic. In one implementation, the COB logic marks the contingent orders so that the COB only executes a trade with the contingent orders where the conditions and/or contingencies as preconditions are satisfied for the contingent order. The contingent orders may be based on spread legs, the risk sensitivity parameters, other underlying legs, or any other condition allowed by the BOM system. In one implementation, an exchange may establish the conditions and contingencies that are valid for a contingent order. In one implementation, the BOM system may limit the number of current contingency based markets. The COB logic monitors all contingent conditions and cancels contingent bids and contingent offers from the COB, where conditions (e.g., time of day, and volatility level) are no longer valid. The execute trade logic attempts to execute trades on contingent orders and returns contingent orders to the COB. In the event a trade on a contingent order fails to execute and the conditions for the contingent order are no longer valid the contingent order is canceled rather than being transmitted to the COB.

In one implementation, when the SOB logic receives a spread order the SOB logic may generate contingent orders to satisfy the spread order, and transmit the contingent orders to the COB. For example, a first trader may have an order on the SOB to buy 1 November 900 Soybean call and sell 1 November 1000 Soybean Call for a debit of 10. The SOB logic may determine a market in the 900 call with a 23 bid and offered at 25 and a market in the 1000 call with a 14 bid and offered at 15. In one implementation, the SOB logic analyzes the spread order to determine combinations of bids and offers that may satisfy the spread order. The SOB logic generates a contingent bid of 24 in the COB so that the 1000 call bid can be traded at 14 resulting in the execution of the spread order. The SOB logic transmits contingent bid to the COB and the market reflects the 900 calls as a 24 bid. The COB will cancel the contingent bid of 24 in the event the bid in the 1000 call changes and/or the call spread in the SOB gets traded, because the two orders are the related contingent markets. In the event a second trader places an order to sell a 900 call at 24, the first trader's bid on the COB can be matched. The execute trade logic determines whether the first trader's bid is locked by another, and locks the markets of the first trader on the COB and other CSBs of the trader. The execute trade logic reserves the 900 call bid of 24 and transmits an order to sell 1 1000 call at 14 FOK to the BOM system. In the event the 1000 call is traded, the execute trade logic calculates the CSBs of the first trader based on the reserved trade being executed to determine that the trading criteria and/or the PRM parameters of the first trader are not violated. The execute trade logic executes the trade in the event the trade is determined to be valid. The first trader's order on the SOB for 1 contract is cancelled and the CSBs of the trader are adjusted based on the validated trade actually being executed. In one implementation, where the first trader's order included more than 1 contract the SOB would have been adjusted and a portion of the first trader's order would remain on the SOB. The first trader buys the 900 Call at 24 from second trader, and the first trader sells the 1000 Call at 14 to the book (the trade had been reserved). All bids and offers of first trader's CSBs are unlocked following the executed trade.

In one implementation, the Volatility Order Book (VOB) is created (for each option class) based on information flowing from the Volatility Pricing and Risk (VPR) Routine that runs for each eligible market participant (PMM). The VPR runs based on a Pricing and Risk Matrix (PRM) submitted and maintained by each eligible market participant (PMM). The matrix can be customized by front end systems that can individually perform a substantial number of complex calculations. The front end systems can evaluate risk, manage risk, and various other calculations based on parameters set by traders and/or risk managers. The front end systems can also extrapolate Implied Volatilities based on instructions given by the user. Once the matrix is submitted to the exchange, the VPR is created for the market participant. A separate VPR runs for each class of options (e.g., December 900 Call, December 800 Puts, March 900 Call are all separate routines).

The VPR runs at each change in the Underlying Market or at each matrix change by the participant, or every time that one of the participants markets are reserved, or at any interval that the exchange decides to run the process. The first step of the VPR routine is to create an Implied PRICE Bid for the appropriate options (IMPB) based on the underlying and the submitted Implied Volatility Bid (IVB). The pricing of the option is based on information provided by the participant. The trader specifies what pricing model (e.g., Black-Scholes, and Whaley) to use as well as what underlying to use. For example, call bids may be priced off of the current bid in the underlying, however, the participant may choose to use a different underlying such as the average of the last 3 trades or even an offset of a different month's bid. The trader may also submit their interest rate information.

Next the system calculates the size of the bid based on risk parameters provided in the matrix (e.g., Maximum long vega at the strike, max delta of trade, max # of short contract per month, etc.), and the pricing model being used. The risk parameters that can be used are virtually unlimited and can be customized by each participant to the degree allowed by the exchange. For practical purposes, the exchange may mandate the use of a certain “standard” model so that delta hedged trades can take place.

The process is then repeated to create the Implied PRICE Offer and size for the appropriate options (IMPA) based on the underlying and the submitted Implied Volatility Offer (IVA). The pricing of the option is based on information provided by the participant. The trader specifies what pricing model (e.g., Black Scholes, Whaley, etc.) to use as well as what underlying to use. For example, call offers may be priced off of the current offer in the underlying, however, the participant may choose to use a different underlying such as the average of the last 3 trades or even an offset of a different month's offer. The trader may also submit their interest rate information.

The size of the offer is calculated based on risk parameters provided in the matrix (e.g., Maximum long vega at the strike, max delta of trade, and max # of short contract per month), and the pricing model being used. The risk parameters that can be used are virtually unlimited and can be customized by each participant to the degree allowed by the exchange. For practical purposes, the exchange may mandate the use of a certain “standard” model so that delta hedged trades can take place.

Since the participant may not frequently change pricing parameters other than Implied Volatility, the exchange may choose to create a table with all possible underlying prices related to the possible IV and Underlying price levels. By doing this, the Theoretical Values (TV) and “Greek Risk Parameters (e.g., Delta, Vega)” are already calculated with each price change. Once the IMPB and IMPA and their respective sizes are calculated, the IMPB and IMPA are sent to the VOB. Once the VOBs runs, the VOBs are consolidated and the conditional orders are sent to the COB. The VPR is constantly updating the VOB and the VOB is being updated based on the freeze/reserve process.

Although selected aspects, features, or components of the implementations are depicted as stored in computer-readable memories (e.g., as computer-executable instructions), all or part of the systems and structures may be stored on, distributed across, or read from other computer-readable media. The computer-readable media may include, for example, secondary storage devices such as hard disks, floppy disks, and CD-ROMs; a signal, such as a signal received from a network or received at an antenna; or other forms of memory, including ROM or RAM, either currently known or later developed.

Various implementations of the BOM system may include additional or different components. A processor may be implemented as a microprocessor, a microcontroller, a DSP, an application specific integrated circuit (ASIC), discrete logic, or a combination of other types of circuits or logic. Similarly, memories may be DRAM, SRAM, Flash or any other type of memory. The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be combined or split among multiple programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of executing a trade in an automated options exchange, the method comprising the steps of:
receiving at a processor a plurality of order books from at least one trader, the order books collectively containing a plurality of bids and offers, the order books being received from the at least one trader via a network operably coupled to the processor;
storing the plurality of order books in a memory associated with the processor;
receiving at the processor price and risk matrix data and trading criteria data from a second trader;
storing the price and risk matrix data and trading criteria data in the memory associated with the processor;
receiving at the processor a request to execute an order from the second trader, the request being received from the second trader via a user interface coupled to the network, the order within the request comprising one or more order parameters;
validating the order contained in the request to execute an order to confirm that the order is valid;
matching the order with one or more of the order books by searching the order books contained in the memory for one of a corresponding bid and a corresponding offer meeting a parameter of the order;
determining whether the one of a corresponding bid and a corresponding offer has been previously locked by the processor as a result of execution or partial execution of another trade;
waiting for the one of a corresponding bid and a corresponding offer to become unlocked if the one of a corresponding bid and a corresponding offer has been previously locked by the processor;
locking an order book contained in memory that contains one of a corresponding bid and a corresponding offer matching the order;
placing a reserve on order books having conditional orders that have been determined match the order;
validating the price and risk matrix data and the trading criteria data associated with the second trader to confirm that fulfilling the order will not violate either the price and risk matrix data or the trading criteria data of the second trader;
executing the trade if the validating step was successful; and
updating the associated order books having at least one of a bid and an offer involved in the trade.

2. The method according to claim 1, wherein the step of executing the trade comprises the sub-steps of:
determining if the trade is a conditional trade contingent upon another trade; and
generating a conditional order to leg the other trade upon which the trade is contingent.

3. The method according to claim 1, further comprising the step of unlocking any order book contained in memory that includes one of a corresponding bid and a corresponding offer matching the order and was previously locked in order to execute the trade.
